(19) United States
(12) Patent Application Publication
(10) Pub. No.: US 2012/0125237 A1
(43) Pub. Date: May 24, 2012

(54) TABLE WITH HEIGHT-ADJUSTABLE COMPONENT

(76) Inventor: Johan Heyvaerts, (US)

(21) Appl. No.: 13/173,920

(22) Filed: Jun. 30, 2011

(30) Foreign Application Priority Data
Nov. 18, 2010 (BE) 2010/0690

(51) Int. Cl. A47B 37/00; A47B 9/04; B23P 11/00; A47B 13/02

(52) U.S. Cl. 108/50.14; 108/161; 108/148; 29/428

(57) ABSTRACT

A table with a height-adjustable component comprising a vertical support, a height adjustable mechanism, and a height adjustable part, wherein the adjustment mechanism comprises at least two grooves around the perimeter of the vertical support; an elastomeric ring which fits snugly within the grooves, and can be stretched to move from one groove to another; and a slide which fits over the vertical support and has a stop which rests on the top of the ring and also prevents lateral movement of the ring out of the desired groove. The height-adjustable part is affixed to or formed as part of the slide, and may comprise a footrest or a tabletop. A method of manufacturing and using the same is also described.

### CROSS-REFERENCE TO RELATED APPLICATIONS

Applicant claims priority from Belgium Patent Application Serial No. 2010/0690, filed on Nov. 18, 2010 by Vanerum Belgie N.V.

### BACKGROUND OF THE INVENTION

Tables with height-adjustable tabletops are known. The height adjustment feature of the tabletops is used for ergonomic reasons, to facilitate a comfortable and practical manner to use the tables. This also allows a table to be used by a growing child for a long time, by adjusting the height of the tabletop from time to time. There are also a number of known adjustment mechanisms for tabletop height adjustment. However, these existing adjustment mechanisms are often impractical to use and/or expensive to implement.

Additionally, in rooms with a number of identical tables, for example classrooms or conference rooms, it can create a messy, unattractive visual image when the tabletops are at varying heights. Another drawback is that tabletops that are adjusted to different heights for their respective users cannot be pushed together on the same level, for example for group work, or to form a large flat table surface.

It may also be difficult to adjust the height of the tabletop itself because of the weight of the tabletop itself, and the additional weight of any objects placed on top of it (such as books or bags). It may also be undesirable to move the tabletop if there are objects placed on the tabletop that preferably would not be moved such as containers filled with spillable liquids, or sensitive measuring equipment which may need to be recalibrated if the accuracy deviates with movement.

These disadvantages are more significant in situations where the adjustment of a tabletop needs to be done frequently, as in situations in which a table often has a different user.

### BRIEF SUMMARY OF THE INVENTION

The present invention relates to a table with a height-adjustable component and a method of manufacturing the table. The adjustment mechanism comprises two or more running grooves located around the perimeter of the vertical support at different heights; an elastomeric ring which fits snugly in each of the grooves; and a slide to which the height-adjustable part is attached, or which is part of the height-adjustable part, wherein the slide is complementarily shaped to the vertical support and can be moved along the length of the vertical support into a position in which the bottom part of the slide rests on the ring. The slide is preferably equipped with a stop to prevent the ring from moving out of the groove when the ring is located in a groove and is supporting the slide. The invention further comprises a method of manufacturing the table, including the height adjustment mechanism.

### BRIEF DESCRIPTION OF THE DRAWINGS

In order to gain better insight into the characteristics of the invention, several preferred designs of a table and a tube are described below according to the invention, as an example without any limitative character, with reference to the accompanying drawings, wherein:

FIG. 1 is a side view of a table according to the invention, as occupied by a person;

FIG. 2 is an enlargement of section F2 shown in FIG. 1;

FIG. 3 is a cross-sectional view of the tube and slide element shown in FIG. 2, along line III-III of FIG. 2;

FIG. 4 is a side perspective view of a tube according to the invention for use in the table shown in FIG. 1;

FIG. 5 is an enlarged view of the free end of the tube shown in FIG. 4;

FIG. 6 is an alternative embodiment of a table according to the invention; and

FIG. 7 is a side perspective view of a tube for use in another embodiment of a table according to the invention.

### DETAILED DESCRIPTION OF THE PREFERRED EMBODIMENTS

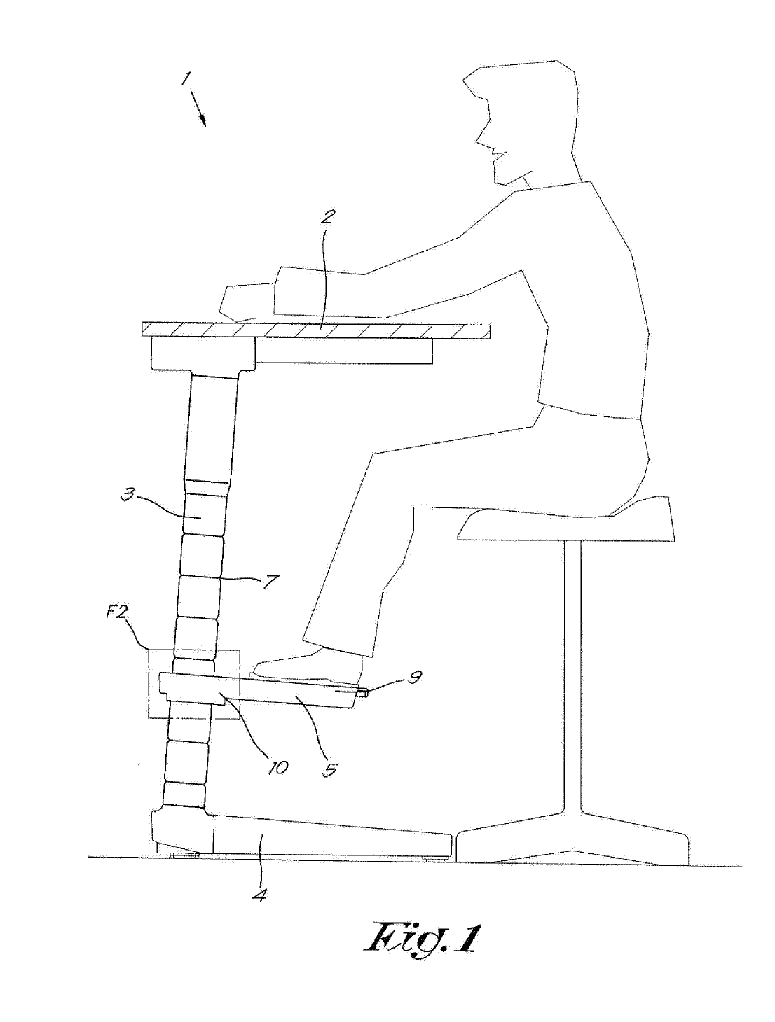

The preferred embodiment of a table indicated in FIG. 1 is a sit-stand desk, which can be used as a desk while sitting on a high chair and can be used while standing behind it to address a room filled with people.

A table 1 has a tabletop 2, one table leg 3, a support foot 4 which supports table leg 3 and with which the table is stabilized on the ground, and a footrest 5 which is height-adjustable by means of an adjustment mechanism. In this preferred embodiment the table has one table leg 3, which makes table 1 cheaper to fabricate and provides ample freedom of movement for the legs of the user.

The table leg 3 is equipped with circumferential grooves 7, at different heights around its outer perimeter 6, with each of the grooves 7 having a rounded shape. An elastomeric ring 8 having a round cross-sectional shape with the same radius as the curvature of the rounded part of the grooves 7, and which fits tightly into a groove 7, is placed about the perimeter 6 of the table leg 3.

The footrest 5 is the height-adjustable part in this preferred embodiment, with footrest 5 comprising a plate-shaped portion 9, and a slide 10 integrated in footrest 5.

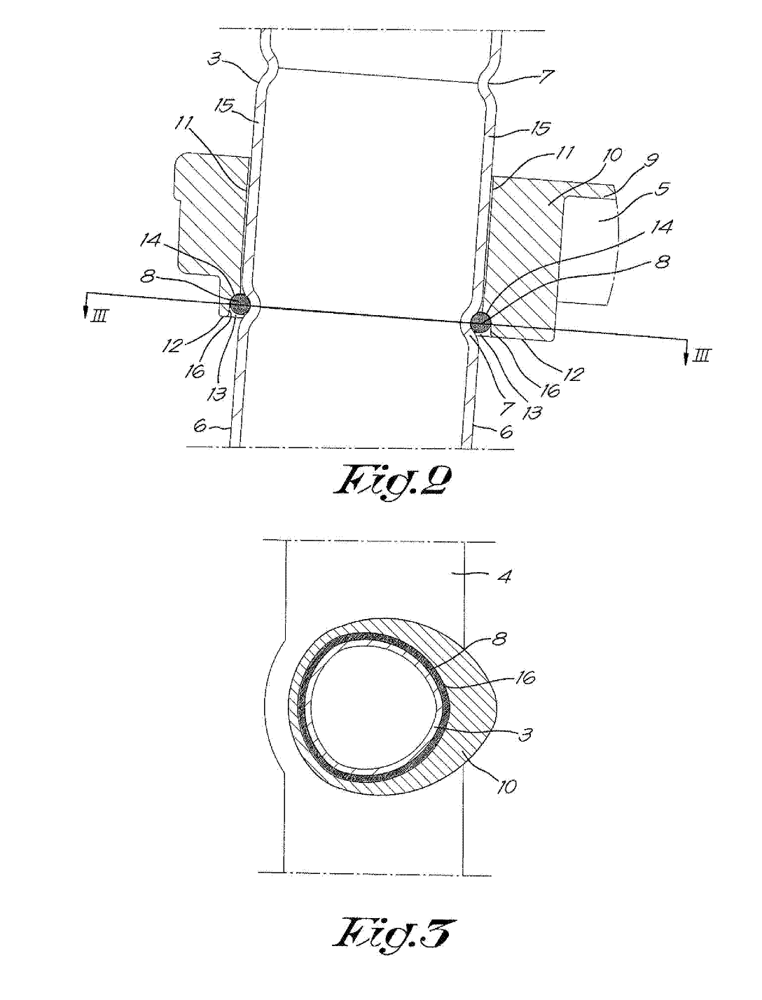

As shown in the embodiment in FIG. 2, slide 10 is a sleeve-shaped part that completely surrounds table leg 3 and which can slide along the length of table leg 3, but which has limited lateral motion with respect to table leg 3. The interior sliding surface 11 of slide 10 defines an opening 11A having a cross-sectional shape which is complementary to outer perimeter 6 of table leg 3.

At the bottom edge 12 of interior sliding surface 11, about the entire inner perimeter, there is a notch 13 with a rounded corner 14 having the same curvature as the radius of the cross-section of ring 8.

This has the advantage that, by adjusting the height of the footrest 5, an ergonomically optimal position can be achieved, while maintaining a constant height of the tabletop 2. By doing so, a more consistent visual image will be achieved with the use of several tables 1 in a room and tables 1 can be placed next to or up against each other to make a larger flat table surface or to promote teamwork. Moreover, it is easier to adjust the height of a relatively small and light footrest 5, than a relatively large and heavy tabletop 2, on which additional articles may also have been placed.

The advantages of providing an adjustable height footrest 5 are particularly evident when table 1 is used as a desk to sit at or a sit-stand desk. A sit-stand desk is a desk behind which a person can stand, for example to give a presentation and at that time it can be used to place notes on or to put a glass of water on, or a desk behind which a person can sit on a high chair to perform standard desk work. Especially with these types of desks, having an adjustable footrest is a great advantage because it allows a more flexible use of the desk.

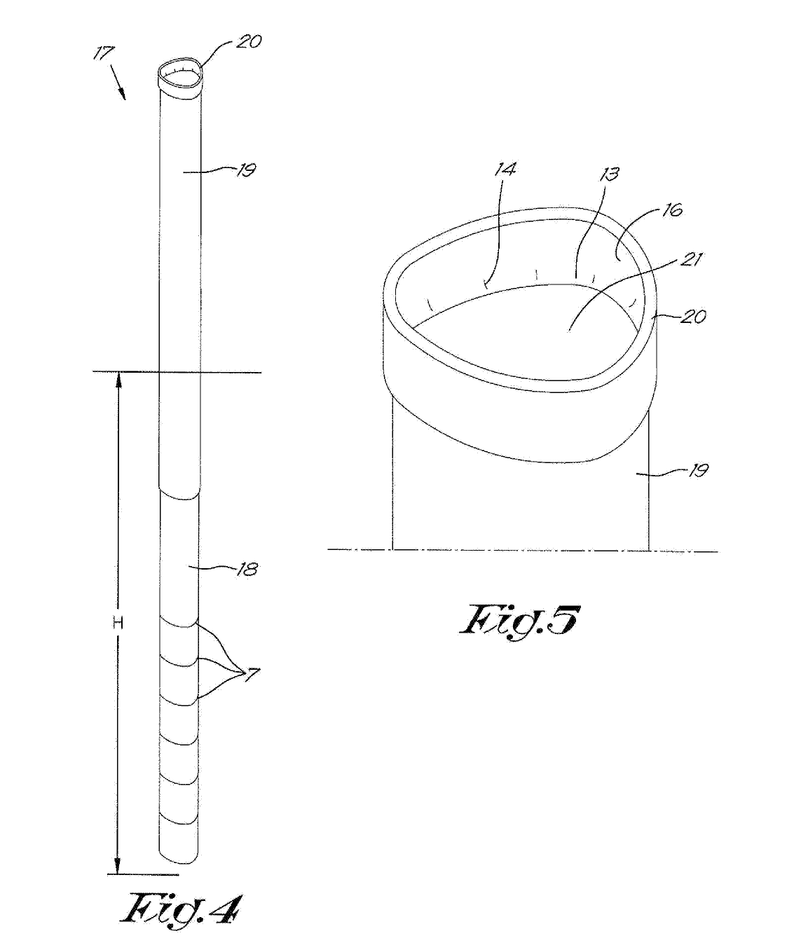

In a preferred embodiment table 1 is also equipped with means to prevent footrest 5 from rotating around table leg 3. This has the advantage that the footrest 5 stays in place to maintain an ergonomical position. One manner of preventing rotation of footrest 5 around table leg 3 is to provide a table leg 3 and slide 10 where the perimeter of table leg 3 and the complementary shape of slide 10 are not round. In this way, without additional parts the rotation of footrest 5 is prevented, while the height-adjustability is maintained. Preferred embodiments may have elliptical cross-sections or cross-sections in the shape of polygons with rounded corners, curved edges or both. As shown in FIG. 3, in a particular preferred embodiment, the outer perimeter 6 of table leg 3 has the shape of a Reuleaux-triangle. Use of shapes without sharp corners are preferable to avoid stress on the elastomeric ring 8. This also applies to the shape of the interior sliding surface 11 of slide 10, which is complementarily shaped.

The height adjustment mechanism comprises grooves 7, ring 8 and slide 10. The operation of table 1 is very simple and as follows: to adjust footrest 5 to the desired height, footrest 5 is pushed up along table leg 3, so that ring 8 is reachable (and is no longer between interior sliding surface 11 and table leg 3). Ring 8 is moved along table leg 3 to the groove 7 which corresponds to the desired height of footrest 5, wherein ring 8, due to its elasticity, fits tightly into groove 7, and can also, when slightly stretched, be moved along certain wider parts 15 of table leg 3 between grooves 7. Preferably, elastomeric ring 8 is rolled along the perimeter 6 of table leg 3 to the desired vertical height. After this, the user will lower footrest 5 along table leg 3 until it reaches the desired height, with the portion of ring 8 that protrudes out of groove 7 seated in notch 13 of footrest 5.

Ring 8 cannot be pushed out of groove 7, even if a downward force is exerted on footrest 5, because the edge of notch 13 works as a stop 16, which prevents lateral movement of ring 8 out of groove 7. Because of this, footrest 5 stays securely in place at the groove 7 having the desired height.

Due to the non-circular shape of outer perimeter 6 of table leg 3 in this preferred embodiment, and the complementary shape of the interior slide surface 11 of slide 10, footrest 5 also cannot rotate around table leg 3, but can only be moved in a vertical direction along the length of table leg 3, as described above. The specific shape of table leg 3 and grooves 7, as a Reuleaux-triangle with rounded corners, ensures that ring 8 fits neatly into groove 7 without making sharp corners, which warrants a smooth functioning and avoids premature deterioration of ring 8 at the corners.

In another embodiment, tabletop 2 has an adjustable height, also using an adjustment mechanism, as shown in FIG. 7. In this embodiment, slide 10 is affixed to tabletop 2 at one end thereof, and the free end 20 is placed over a table leg 22. The height of tabletop 2 is then adjusted in a manner analogous to footrest 5, as described above, wherein tabletop 2 is the height-adjustable part. Slide 10 preferably has a relatively long length to provide additional height adjustability without table leg 22 extending through the upper surface of tabletop 2.

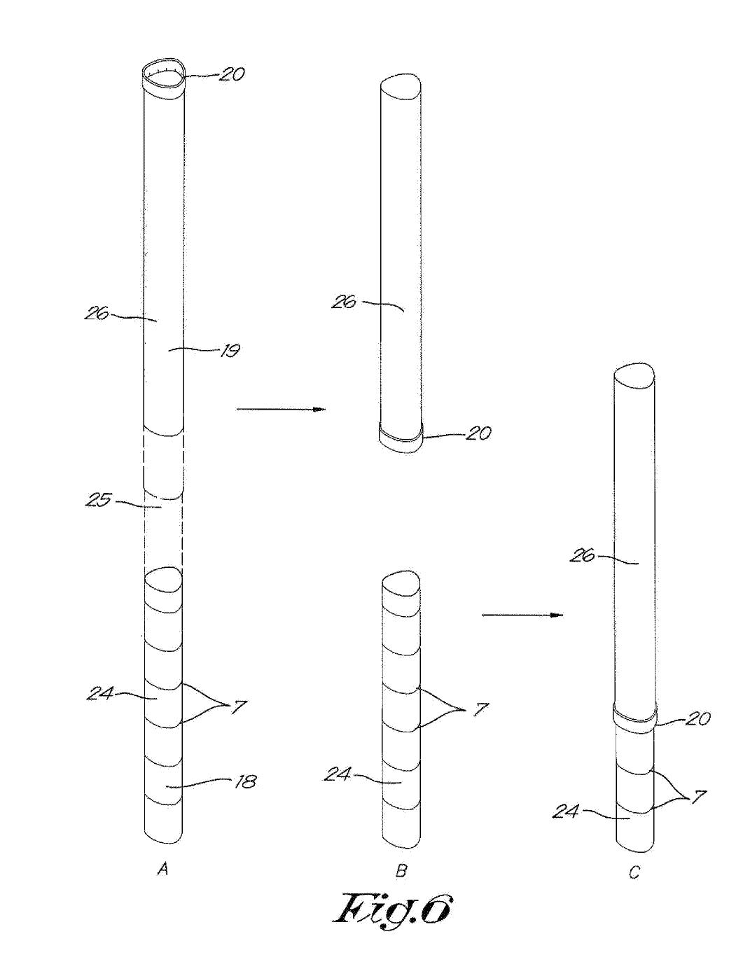

A preferred method of manufacturing a table leg 3 suitable for an above mentioned table 1, and also for other tables, even tables without a separate height-adjustable part, begins with a preformed tube 17, as shown in FIGS. 4 and 5, wherein tube 17 is formed out of a round metallic tube by hydro-forming.

Such a tube 17 comprises a thin portion 18, i.e., with a relatively smaller diameter, and a thick portion 19, i.e., with a relatively larger diameter. The thin portion 18 is equipped with grooves 7. Tube 17 is also formed into the rounded triangular cross-sectional shape of a Reuleaux-triangle.

Tube 17 is preferably hollow, and the dimensions of the thin and thick portions 18, 19 and the wall thickness of tube 17 are such that a cavity 21 in thick portion 19 is sized to closely receive the thin portion 18 of a second tube 17. The free end 20 of thick portion 19 is equipped with a notch 13 on its interior surface.

The manufacture of two embodiments of table legs 3, 22 is simple and also rendered in FIGS. 4, 6 and 7.

To assemble a table leg 3 for the first embodiment, shown as table 1 according to FIG. 1, tube 17 is simply brought to the correct length H by removing a section of the thick portion 19. (FIG. 4) After this, ring 8 and slide 10 can be installed by sliding over the end of tube 17.

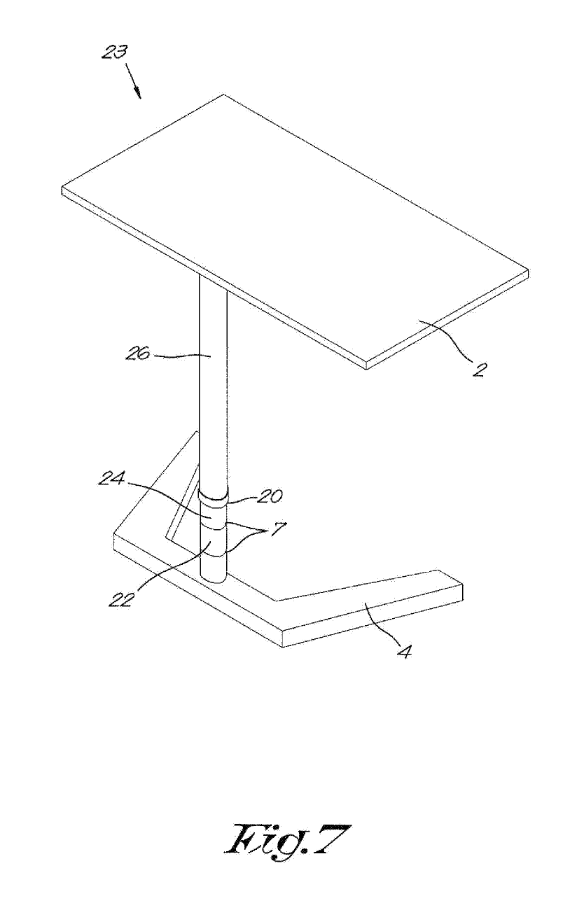

To manufacture another embodiment of a table leg 22 for a table 23 wherein the adjustable-height part is the tabletop 2, as shown in FIG. 7, tube 17 is divided into three pieces, as shown in FIG. 6, namely a bottom piece 24 which is formed entirely out of the thin portion 18, a middle piece 25 which is partly formed out of the thin portion 18 and partly out of the thick portion 19, and a top piece 26, which is formed entirely out of the thick portion 19. The middle piece 25 is not needed to make table leg 22. The top part 26 is reversed, and its free end 20 is slid over the bottom part 24. By doing so, the bottom part 24 becomes the table leg 22, and the reversed top part 26 becomes the slide 10 of an adjustment mechanism, and thus, after ring 8 has been installed around table leg 22, a table leg 22 with adjustment mechanism has been made.

Tables according to the present invention are not limited to tables with one table leg. Tables with more than one table leg are also possible. Only one table leg can be provided with the height-adjustment mechanism, or more than one leg or even every table leg can be provided with a height-adjustment mechanism. If more than one table leg is provided with a height-adjustment mechanism, then of course it is not necessary to provide means to prevent rotation of the height-adjustable part.

Even though in the preferred embodiments shown in the Figures the slide completely surrounds the table leg, this is not necessary for the invention. The slide can also partially surround the table leg or could have a protrusion which slides into a notch in the table leg or vice versa.

Even though grooves 7 are applied at regular intervals from each other in the embodiments rendered in the Figures, the invention can also be made with grooves applied at different intervals.

Further, notch 13 in slide 10 does not have to be applied, as drawn in the Figures, around the entire interior sliding surface 11 of slide 10, but can also be partly applied, or can even be limited to a few concrete stops. A rounding of notch 13, in order to match the shape of ring 8, is also preferable, but not necessary.

Even though the footrest of the above-mentioned table has been proposed as a piece mainly made up out of one shaped part, in which the slide is integrated, the slide can also be a separate part, to which the height-adjustable part, directly or indirectly, is mounted.

The present invention is in no way limited to the embodiments described as examples and as rendered in the Figures, yet a table and tube according to the invention can be achieved in various shapes and sizes without stepping outside the framework of the invention, as defined by the claims.

1. A table with an adjustable height component, comprising:
a vertical support; and
a height-adjustable part wherein the height is adjusted by an adjustment mechanism, wherein the adjustment mechanism comprises two or more grooves at different heights around the perimeter of the vertical support, an elastomeric ring which is sized to fit snugly in the groove and is longitudinally movable along the vertical support for placement in the groove at the desired height, and a longitudinally movable slide having a stop to prevent the ring from slipping out of the desired groove when the slide engages the ring.

2. A table according to claim 1, wherein the grooves and the ring have complementary cross-sectional shapes, wherein the ring fits tightly into the grooves and extends outward therefrom beyond the perimeter of the vertical support.

3. A table according to claim 1, wherein the slide comprises an interior sliding surface which extends at least half way around the perimeter of the vertical support and which is the surface adjacent to the vertical support, defining an opening through which the vertical support passes when the adjustable-height part is installed on the table.

4. A table according to claim 3, wherein the opening defined by the interior sliding surface and the perimeter of the vertical support have complementary shapes.

5. A table according to claim 3, wherein the interior sliding surface extends around the entire perimeter of the table leg.

6. A table according to claim 5, wherein the slide is an integral part of the height-adjustable part.

7. A table according to claim 1, wherein the bottom of the interior sliding surface of the slide rests on the ring in the groove.

8. A table according to claim 7, wherein the stop is a notch which extends around the bottom of the interior sliding surface, and wherein the notch fits snugly against outer surface of the ring when the ring is in the groove, and does not have a circumference sufficient to accommodate the ring when the ring is not in the groove, thereby preventing the ring from moving outwardly from its position in the groove.

9. A table according to claim 1, wherein the height-adjustable part is a footrest.

10. A table according to claim 1, wherein the height-adjustable part is a tabletop.

11. A table according to claim 1, wherein the table has a single vertical support.

12. A table according to claim 1, wherein the table is equipped with means to prevent the adjustable-height part from rotating around the vertical support.

13. A table according to claim 12, wherein the means of preventing rotation is that the perimeter of the vertical support and the opening defined by the interior sliding surface are not circular.

14. A table according to claim 13, wherein the perimeter of the vertical support and the opening of the interior sliding surface have the shape of a rounded Reuleaux-triangle.

15. A tube for use as the vertical support of a table as described in claim 1, comprising:
a first portion with a relatively smaller diameter, having at least two grooves running around the perimeter of the first portion; and
a second portion with a relatively larger diameter, wherein the second portion has a hollow cavity therein, and wherein the hollow cavity has a shape and size sufficient to at least partially receive the first portion of the tube therein.

16. A method of manufacturing a table with an adjustable-height part, comprising the following steps:
separating a shaped tube into a first portion and a second portion, wherein the first portion has a relatively smaller diameter and has at least two grooves running around its perimeter and the second portion has a relatively larger diameter with a cavity defined therein, such that the first portion fits at least partially within the cavity;
placing an elastomeric ring around the first portion at the groove having the desired height;
affixing the height-adjustable part to the second portion; and
sliding the cavity of the second portion downward over the first portion until the height-adjustable part is at the desired height.

17. The method of manufacturing a table with an adjustable-height part as described in claim 16, wherein the second portion has an opening at each end thereof.

18. The method of manufacturing a table with an adjustable-height part as described in claim 17, wherein the height-adjustable part is a footrest.

19. The method of manufacturing a table with an adjustable-height part as described in claim 16, wherein the height-adjustable part is a tabletop, and wherein the second portion has a relative length which is sufficient to allow its bottom edge to extend to more than one groove of the first portion without the first portion extending through the top edge of the second portion.
